(19) United States
(12) Patent Application Publication
(10) Pub. No.: US 2006/0224482 A1
(43) Pub. Date: Oct. 5, 2006

(54) Systems and methods for managing an asset inventory

(76) Inventors: James Kenneth Aragones, Clifton Park, NY (US); Naresh Sundaram Iyer, Clifton Park, NY (US); Amy Victoria Aragones, Clifton Park, NY (US)

Correspondence Address: Patrick S. Yoder;FLETCHER YODER, P.O. Box 692289, Houston, TX, 77269-2289, US

(21) Appl. No.: 11/095,242

(22) Filed: Mar. 31, 2005

(51) Int. Cl. G06Q 40/00

(52) U.S. Cl. 705/35

(57) ABSTRACT

A method of managing an asset inventory is provided. The method includes obtaining data related to assets of the asset inventory and analyzing the obtained data to estimate a total number of assets required by the asset inventory over a time period. The method also includes determining a first cost of owning an asset and a second cost of leasing an asset and allocating the asset inventory between a first number of owned assets and a second number of leased assets to achieve an estimated least-cost value of maintaining the total number of assets over the time period.

### BACKGROUND

The present invention relates generally to a technique for managing an asset inventory and, more particularly, to methods and systems for managing a spare engine inventory for a fleet of aircrafts.

Various service organizations establish long-term contractual agreements with their customers, contracting to provide a broad scope of services for a given term. For example, engine services organizations often establish long-term service agreements (LTSA's) with airlines to provide most maintenance requirements for the engines of an airline's fleet. Thus, if an engine requires maintenance or repair during the contractual term, the LTSA requires the service organization to properly address such issue. Unfortunately, repairing or maintaining an engine often requires taking the engine off-line and grounding the associated aircraft. Indeed, maintenance may require shipping the engine off-site to a maintenance facility with a turn around time of three-months or so, for example.

Accordingly, LTSA's generally require that the service organization maintain an inventory of spare engines, ensuring availability. In some cases, the LTSA also requires the airline to maintain an inventory of spare engines as well. Maintaining an inventory of engines is an expense to the service provider and/or the airline. If too many spare engines are maintained, necessary capital can be tied-up. By contrast, if too few spare engines are available, the service provider or airline may be forced to lease the necessary engines from a third-party, generally at premium. In certain cases, a spare engine may not be available, leading to contractual penalties, for instance.

Therefore, there is a need for an improved technique for managing an asset inventory. Particularly, there is a need for systems and methods that reduce the total cost of maintaining the asset inventory.

### BRIEF DESCRIPTION

In accordance with one exemplary embodiment, the present technique provides a method of managing an asset inventory. The method includes obtaining data related to assets of the asset inventory and analyzing the obtained data to estimate a total number of assets required by the asset inventory over a time period. The method also includes determining a first cost of owning an asset and a second cost of leasing an asset, and allocating the asset inventory between a first number of owned assets and a second number of leased assets to achieve an estimated least-cost value of maintaining the total number of assets over the time period. The method also includes determining a schedule for leasing the second number of assets to be leased for the asset inventory Computer-readable medium that afford functionality of the type defined by this method is also provided by the present technique.

In accordance with another exemplary embodiment, the present technique provides a system for managing an asset inventory. The system includes a database having data related to assets of the asset inventory. The exemplary system also includes a processor that facilitates analysis of data stored in the database, to estimate a total number of assets required by the asset inventory over a time period and to allocate the asset inventory between a first number of owned assets and a second number of leased assets to substantially reduce the costs of maintaining the total number of assets, for instance.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary service cycle for a fleet of engines, in accordance with an exemplary embodiment of the present technique;

FIG. 2 is a diagrammatical representation of a system for predicting timing and costs of service events for the components of the engine managing a spare engine inventory for the fleet of engines of FIG. 1, in accordance with an exemplary embodiment of the present technique;

FIG. 3 is a flow chart illustrating an exemplary process for predicting the timing and cost of service events for a fleet of engines, in accordance with an exemplary embodiment of the present technique;

FIG. 4 is a flow chart illustrating an exemplary process for predicting failure events for components of an engine for a fleet of engines, in accordance with an exemplary embodiment of the present technique;

FIG. 5 is a flow chart illustrating an exemplary process for predicting failure events for a fleet of engines, in accordance with an exemplary embodiment of the present technique;

FIG. 6 is a diagrammatical illustration of a system for predicting shop load distributions for a fleet of engines, in accordance with an exemplary embodiment of the present technique;

FIG. 7 is a flow chart illustrating an exemplary process for managing a spare engine inventory for a fleet of engines, in accordance with an exemplary embodiment of the present technique;

FIG. 8 is a graphical representation of an exemplary cost distribution of managing a spare engine inventory for a required number of spare engines, in accordance with an exemplary embodiment of the present technique; and

FIG. 9 is a graphical representation of an exemplary cost distribution of managing a spare engine inventory over a period of time for a required number of spare engines, in accordance with an exemplary embodiment of the present technique.

### DETAILED DESCRIPTION

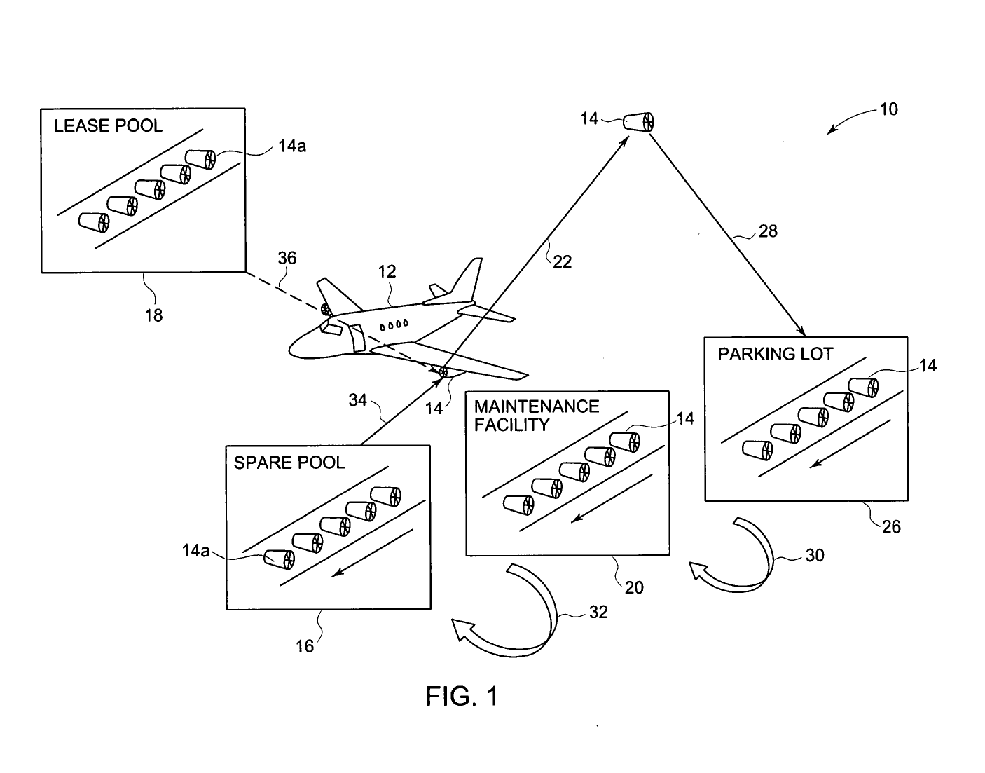

As discussed in detail below, embodiments of the present technique function to provide a method of managing an asset inventory for a product. Although the present discussion focuses on managing a spare engine inventory for a fleet of aircraft, the present technique is not limited to engines. Rather, the present technique is applicable to any number of suitable fields in which asset management is desired. Referring now to the drawings, FIG. 1 illustrates an exemplary service cycle 10 of an engine fleet of an aircraft 12. For illustration purposes, only one aircraft 12 of an aircraft fleet is shown, however, in practice the aircraft fleet may include any number of aircrafts. From time-to-time, it may become necessary to remove one or more engines 14 from the aircraft 12. For example, the engine 14 may be removed from the aircraft 12 for an overhaul of the components of the engine 14, because of improper operation of the engine 14, because of routine or preventive maintenance, among a host of conditions. As a result, a replacement engine 14a may be required for an uninterrupted operation of the aircraft 12.

Typically, the replacement engine 14a is provided through a spare pool 16 that includes a plurality of stand-by engines. It should be noted that an airline or a service provider for the airline owns an appropriate number of engines in the spare pool 16 that may be utilized as replacement engines 14a for the aircraft 12, for example. Alternatively and by way example, if the replacement engine 14a is not available via the spare pool 16, then the replacement engine 14a may be leased from a lease pool 18 for a required time period. Typically, lease pools 18 are operated by a third-party.

Once removed from the aircraft 12, the engine 14 is often transported to a maintenance facility 20 for overhauling or repair, as represented by reference numerals 22. Typically, the removed engine 14 is placed in a “parking lot” 26 (i.e., an interim storage facility), as represented by reference numeral 28. When placed in the parking lot 26, the removed engine 14 enters a queue for transportation to the maintenance facility 20 for maintainence. Depending on the availability of space at the maintenance facility 20, the engine 14 enters the facility 20 for maintainence, as represented by reference numeral 30. In certain embodiments, if the parking lot is empty, the removed engine 14 may be directly transported to the maintenance facility 20. Subsequently, the removed engine 14, once appropriately addressed, may be stored in the spare pool 16, as represented by reference numeral 32. Accordingly, the overhauled engine 14 from the spare pool 16 may be employed as the replacement engine 14a for the aircraft 12, as represented by reference numeral 34. As mentioned before, if a spare engine is not available in the spare pool 16, the engine 14 may be leased or purchased from the lease pool 18, as represented by reference numeral 36. Also, if the number of engines in the spare pool 16 falls below a given contractual threshold, it may be necessary to lease or purchase additional engines from the lease pool 18. When a spare engine is available for use as a replacement engine 14a, leased engines from the lease pool 18 may be returned by replacing it with a newly repaired spare engine from the spare pool 16.

As mentioned above, an engine 14 removed from an aircraft 12 is replaced by a spare engine from the spare pool 16 or by a leased engine from the lease pool 18. Thus, an airline or a service provider for the airline manages a spare engine inventory by allocating the inventory between owned and leased engines. Advantageously, the present technique facilitates optimization of the asset inventory between leased and owned engines, for example.

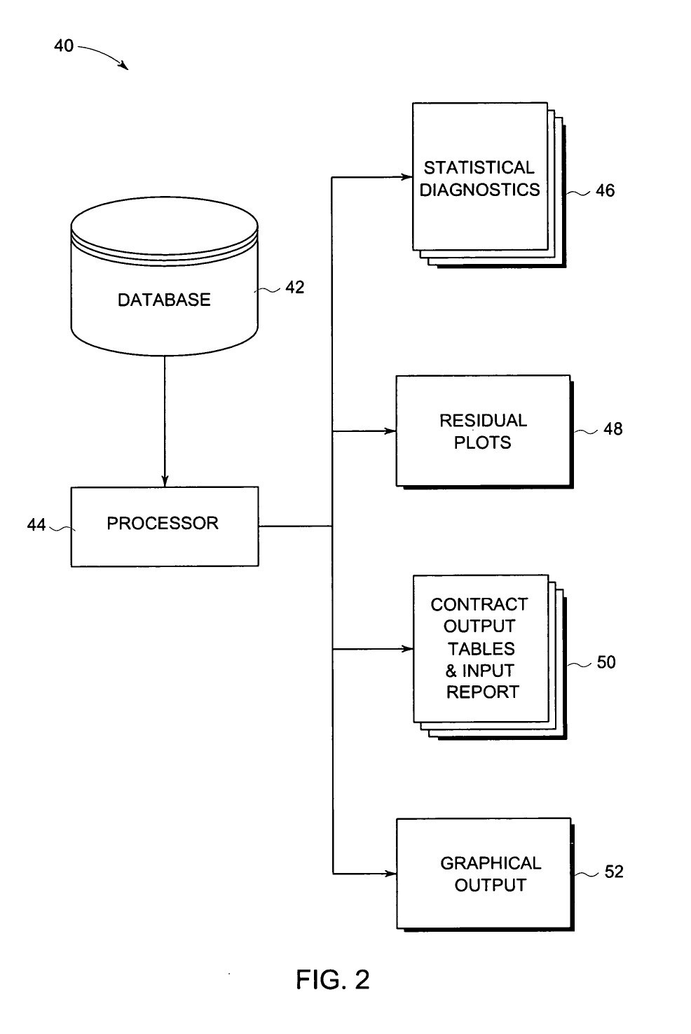

FIG. 2 illustrates a system 40 for predicting timing and costs of service events for the components of the engine for managing a spare engine inventory for the fleet of engines of FIG. 1. Such a system 40 is described in U.S. Pat. No. 6,799,154, which is incorporated herein by reference. The exemplary system 40 includes a database 42 having data related to engines for a spare engine inventory. In addition, the system 40 includes a processor 44 that facilitates analysis of the stored data, to predict timing and cost of service events for a fleet of engines and to estimate a total number of spare engines required by the spare engine inventory over a time period. By way of example, the processor 44, in cooperation with various algorithms, may determine failure models that provide an indication of the spare engine needs for a given fleet. Also, the processor 44, as discussed further below, facilitates allocation of the spare engine inventory between a first number of owned engines and a second number of leased engines to substantially reduce a cost of maintaining the total number of spare engines, as discussed further below.

In a presently contemplated configuration, the database 42 contains data related to the engine 14 of the aircraft 12. Generally, such data includes information such as compartment definitions of the engine, repair history of the engine, environment, operating conditions of the engine, engine life, among others. It should be noted that, as used herein, the term “compartment definition” refers to a physical or performance related subsystem of the engine 14, which, when it fails, suggests that the engine 14 needs maintenance or servicing. In addition, the database 42 may include data such as engine utilization, engine lease acquisition cost, engine repair cost, engine maintenance turnaround time, engine transport time, engine depreciation, engine purchase cost, engine storage cost, engine ownership cost and contract terms. In this embodiment, the plurality of data mentioned above may be stored via a memory device that includes a random-access memory (RAM) and a read-only memory (ROM). However, other types of memory such as programmable read-only memory (PROM), erasable read-only memory (EPROM) and electrically erasable programmable read-only memory (EEPROM) may be employed for storing the data.

Typically, the processor 44 preprocesses the data from the database 42 to generate data in a pre-determined format. In certain embodiments, the preprocessing includes extracting the data from the database 42, assigning each data record in the database 42 to a compartment depending upon various factors such as removal cause, failure mode and so forth. The formatted data may be then analyzed to estimate a total number of engines required by the spare engine inventory over a time period based upon the obtained data. It should be noted that the total number of engines required by the spare engine inventory depends upon failure rate distributions of the components of the engine that are estimated by the processor 44 as described below.

The processor 44 facilitates determination of a plurality of compartment failure data that may include compartment failure parameters and compartment time-to-failure coefficients. As used herein, the term “compartment failure parameters” includes variables that affect the time required for a component of the engine 14 to be serviced. Further, it should be noted that, as used herein, the term “compartment time-to-failure coefficients” includes coefficients that are applied to each of the compartment failure parameters. Further, based upon the estimated compartment failure parameters and the compartment time-to-failure coefficients, the processor 44 estimates failure rate distributions for the components of the engine 14.

In certain embodiments, the processor 44 may cooperate with a statistical analyzer to analyze the data and to execute a plurality of statistical procedures to determine a plurality of compartment failure information, such as statistical diagnostics 46 and residual plots 48. Examples of statistical procedures include multi-variate regression and correlation analysis. The statistical diagnostics 46 may include the compartment time-to-failure coefficients for each compartment associated with the engine. Further, the residual plots 48 enable a user of the system 40 to determine how well the regression model fits into the obtained data, for example.

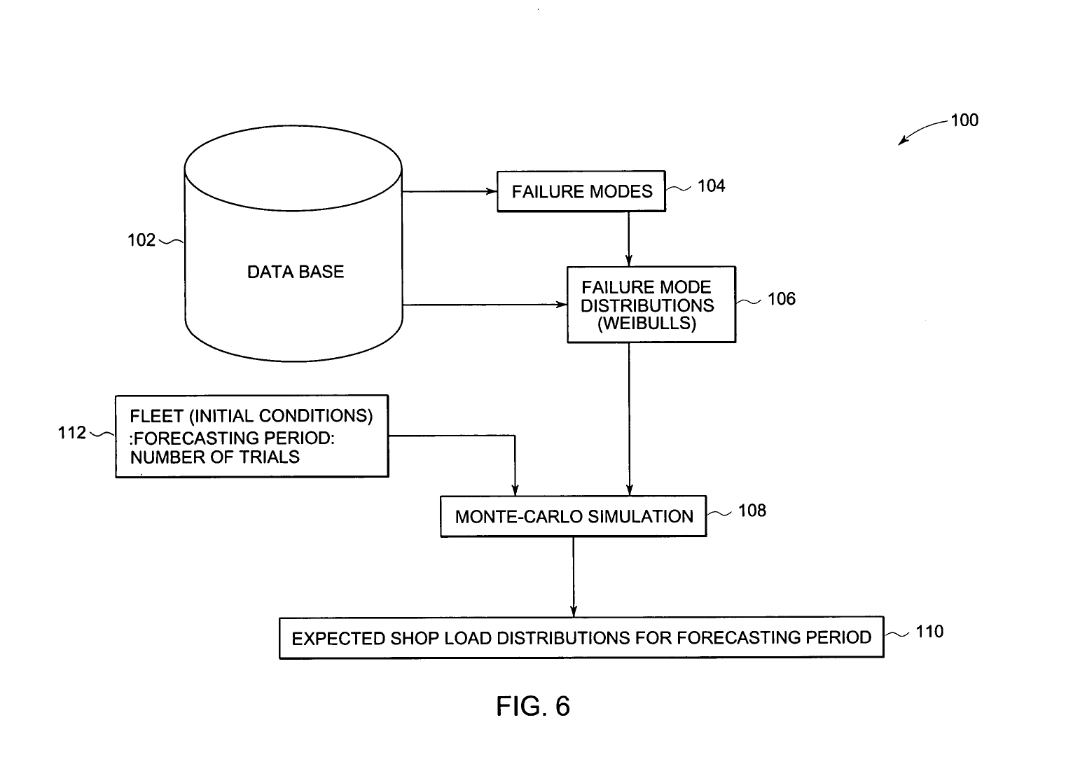

Moreover, the processor 44 cooperates with a simulator that is configured to forecast failure of the components of the engine over the time period based upon the estimated failure rate distributions of the components. The simulator may be a part of the processor 44 or may be isolated from the processor 44. In particular, the simulator utilizes the compartment time-to-failure coefficients and determines a Weibull distribution for each compartment and such distributions may be employed to determine the overall distribution of the engine. In one embodiment, the simulator employs an event driven Monte Carlo simulation. As a result of the simulation the simulator generates several outputs such as a contract output report 50 and a graphical output 52. The contract output report 50 may include a plurality of information such as maintenance event distribution parameters over the time period, maintenance cost distribution over the time period, demand distributions and so forth. Further, the graphical output may include cost distributions, availability, reliability and other financial information. Thus, from the estimated outputs from the processor 44 information pertaining to various parameters of the components of the engine may be made available to a user of the system 40. Further, this information may be used for managing the spare engine inventory as will be described further below with reference to FIG. 6.

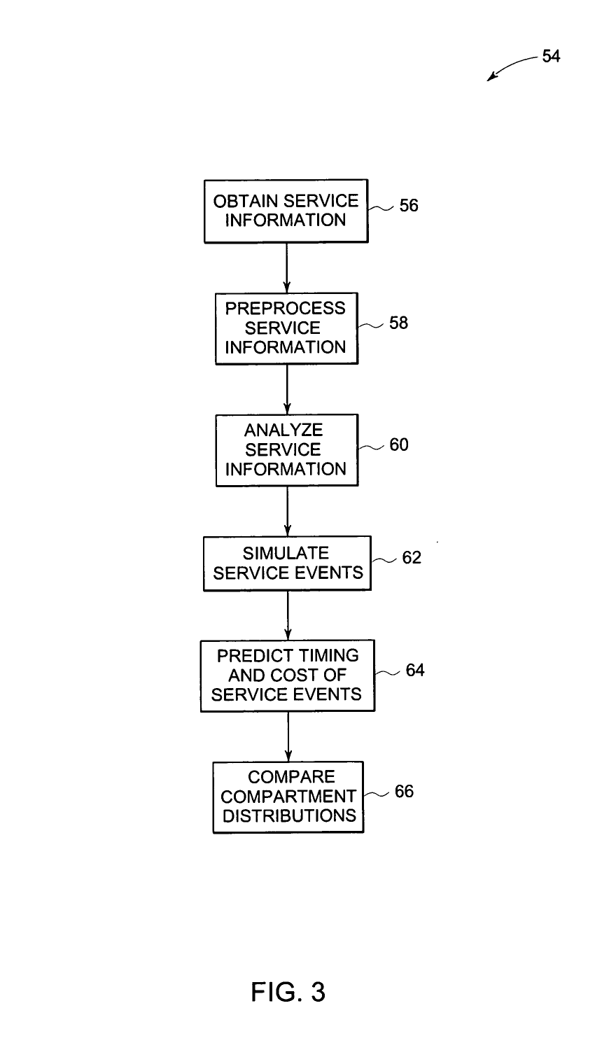

FIG. 3 illustrates in block form an exemplary process 54 for predicting the timing and cost of service events for the fleet of engines of FIG. 1. As illustrated, the process 54 includes obtaining service information for the engines stored in the database as represented by step 56. Generally, such service information includes data such as compartment definitions of the engines, repair history of the engines, environment, operating conditions of the engine, engine life, among others. At step 58, the obtained service information is preprocessed into a pre-determined format. Further, the pre-processed information is analyzed to determine a plurality of compartment failure information for the engine as represented by step 60. At step 62, the simulator simulates the service events of the engine according to the compartment failure information and predicts the timing and cost of the service events as represented at step 64. In certain embodiments, the compartment distributions obtained from the simulator may be compared to distributions from a case study for validation as represented by step 66.

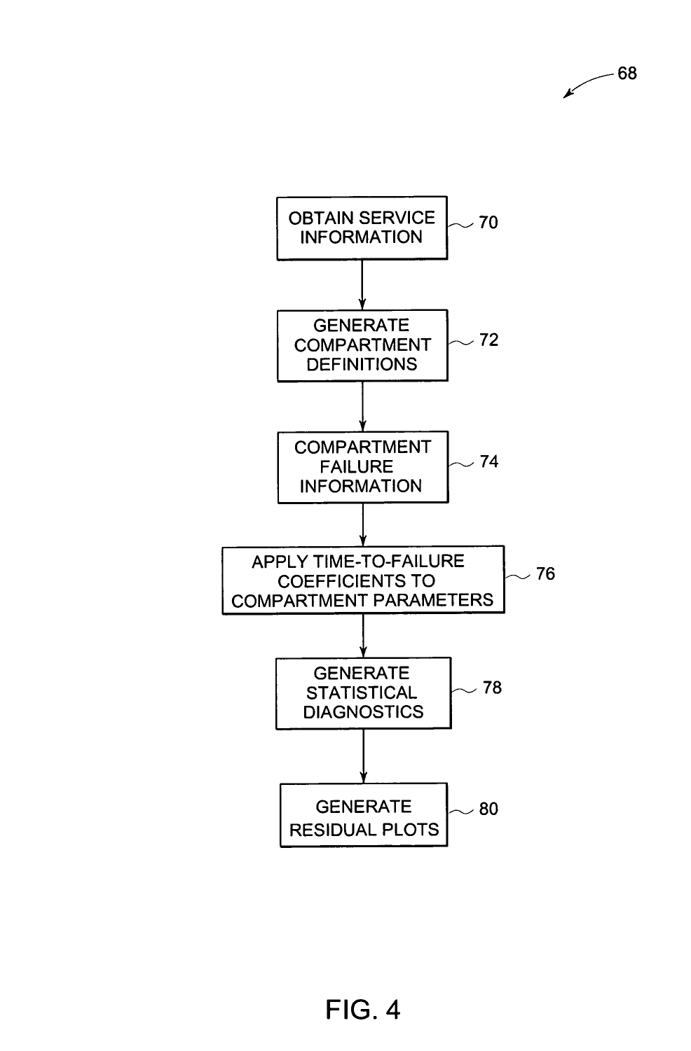

Referring now to FIG. 4, an exemplary process 68 for predicting failure events for components of an engine for the fleet of engines of FIG. 1 is illustrated. The process 68 includes obtaining service information at step 70 and generating compartment definitions for the engine for the obtained service information as represented by step 72. Further, at step 74 the processor determines the compartment failure information that includes compartment failure parameters and the compartment time-to-failure coefficients. Moreover, the compartment time-to-failure coefficients are applied to the compartment failure parameters at step 76. At step 78, statistical diagnostics report for each compartment of the engine is generated via an analyzer and residual plots and probability plots are generated as represented by step 80.

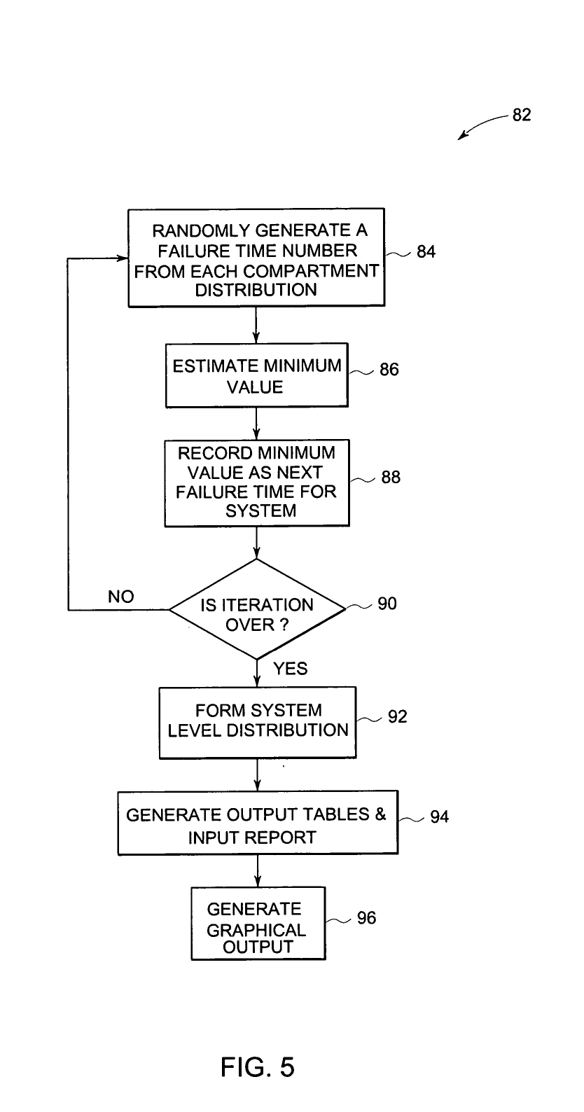

FIG. 5 illustrates an exemplary process 82 for predicting failure distributions for an engine using the system of FIG. 2. The process 82 facilitates prediction of the distribution of failure at the engine level based upon the compartment distributions. In this embodiment, the process 82 includes generating a random number of failure times from each compartment distribution as represented by step 84. At step 86, the minimum of values from the generated numbers of failure times is estimated. Further, the minimum time is recorded by the simulator as the next failure time as represented by step 88. At step 90, the simulator determines if there are any more system level failures required. If the simulator determines that more number of system level failures is required then the steps 84-88 are repeated until there are enough failure times. Subsequently, the simulator determines a system level failure distribution from the failure times as represented by step 92. At step 94, the simulator generates output tables and the input report, while a graphical output is generated at step 84.

As described above, the failure distributions for an engine from a fleet of engines are estimated based upon the obtained data related to the engines. Advantageously, the failure distributions may be utilized for determining shop load distributions over a time period as described with reference to FIG. 6.

FIG. 6 illustrates a system 100 for predicting shop load distributions for the fleet of engines of FIG. 1. The system 100 includes a database 102 having historical failure data related to the components of the engines. In the illustrated embodiment, the system 100 utilizes the historical failure data from the database 102 and failure modes 104 for the components of the engine to determine Weibull distributions 106 for each of the failure modes 104. Examples of failure modes include gear box related failure, combustor failure, foreign object damage, high pressure compressor failure, high pressure turbine failure, life limited part, low pressure system failure, maintenance error, slow acceleration and combinations thereof. Further, a Monte Carlo simulation 108 may be employed to determine shop load distributions 110 over the time period. In this embodiment, the Monte Carlo simulation utilizes parameters 112 such as initial fleet conditions, forecasting period and number of trials to determine the shop load distributions 110 for the forecasting period. The estimated shop load distributions 110 along with certain other aforementioned parameters are utilized for managing the spare engine inventory for the fleet of engines.

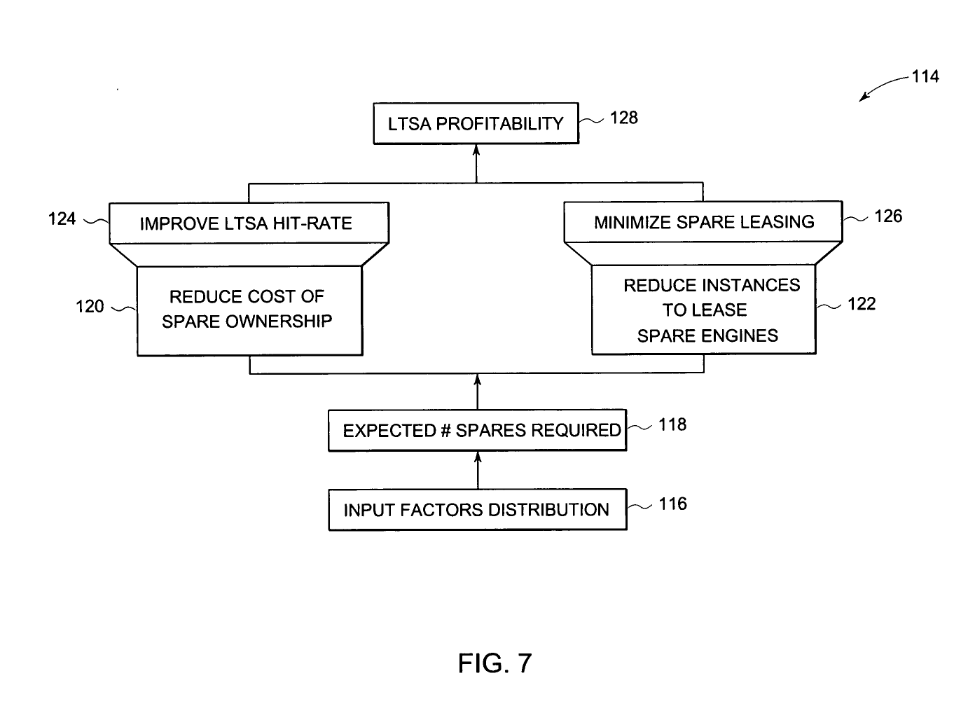

Referring now to FIG. 7, an exemplary process 114 for managing a spare engine inventory for a fleet of engines is illustrated. The process 114 includes estimating the input factors distributions as represented by step 116. As previously described, the input factors distributions includes distributions for factors such as engine utilization, engine lease acquisition cost, engine repair cost, engine life, engine maintenance turn around time, engine transport time, engine depreciation, engine purchase cost, engine storage cost and engine ownership cost. Further, the input factor distributions also include estimated shop load distributions for the engine inventory as described above with reference to FIGS. 2-6. The obtained data for the input factors distribution is analyzed to estimate a total number of engines required by the spare engine inventory for the time period as represented by step 118. In this embodiment, the analysis of the data includes determining failure rate distributions for the components of the engine and forecasting failure of the components of the engines over the time period. Thus, based on these predicted failures and failure rate distributions, an estimate of the number of spare engines likely needed for a give time period can be made.

The estimated total number of engines required by the spare engine inventory may be allocated between a first number of owned engines and a second number of leased engines, the allocation being optimized to reduce the expected total costs of maintaining the total number of spare engines over the time period. In this embodiment, a first cost of owning an engine and a second cost of leasing an engine are determined to estimate the cost of maintaining the total number of assets over the time period. As discussed further below, the cost of maintaining the total number of assets may be substantially reduced by balancing the cost of owning the engines against the cost of leasing the engines in accordance with implementations of the present technique. In the illustrated exemplary embodiment, the allocation of inventory between owned and leased engines is done such that the cost of ownership of spare engine is reduced and the instances when the airline or the service provider is unexpectedly required to lease engine from a lease pool is also reduced, as represented by steps 120 and 122. This optimized allocation of the asset inventory between the owned and leased engines is discussed further below.

The allocation of the asset inventory between the owned and leased engines is done based upon the tradeoff between the first number of owned assets and the second number of leased assets to optimize the cost of maintaining the total number of assets. As a result, the allocation of the engines may advantageously improve a LTSA hit-rate and would also minimize spare engines leasing for the airline or the service provider (steps 124 and 126). As illustrated by step 128, the allocation of the spare engine inventory between the first number of owned assets and a second number of leased engines results in achieving LTSA profitability, thereby reducing the cost of maintaining the total number of engines.

The following discussion provides an exemplary process for determining the optimized allocation between leased and purchased spare engines. The cost of maintaining the total number of engines over a time period, say a month m for instance, is represented by the following equation:
Cₘ=C_{L}+C_{O} (1)
C_{L}=MAX[E(#spares in use at end of month m)−#spares owned]*Lₘ (2)
C_{O}=MAX[#spares owned−E(#spares in use at end of month m)]*L_{O} (3)

Where
C_{O} is the cost of owning the first number of engines;
C_{L} is the cost of leasing the second number of engines;
L_{O} is the owning cost for an engine per month;
Lₘ is the leasing cost for an engine per month and
E (#spares in use at end of month m) is a function of shop load for the month m.
   Thus, the above-mentioned function for the cost of maintaining the total number of spares may be minimized to determine the first number of owned engines and the second number of leased engines for the spare engine inventory. By way of example, if the leasing cost for a spare engine is $20 k per month and the owning cost of a spare engine is $10 k per month, then the cost of maintaining the total number of engines is given by:
   Cₘ=MAX[E(#spares in use at end of month m)−#spares owned]*20+MAX[#spares owned−E(#spares in use at end of month m)]*10 (4)
   Based upon the shop load distribution for the month m, the cost of maintaining the total number of engines may be determined by equation 4. The shop load distribution for the particular month m may be predicted from the input factors distribution as described above with reference to FIGS. 2-6. For instance, this shop load distribution is determined based on the estimated failure modes and failure rate distributions as discussed above. This estimated cost of maintaining the total number of engines may be minimized for allocating the inventory between leased and owned engines. Moreover, the technique also includes determining a leasing schedule for leasing the second number of leased assets to substantially reduce the cost of maintaining the total number of assets over the time period. In this embodiment, the leasing schedule of the spare engines is managed such that a required number of lease engines are available during the time period when the asset inventory has insufficient spare engines for uninterrupted operation of the aircraft.

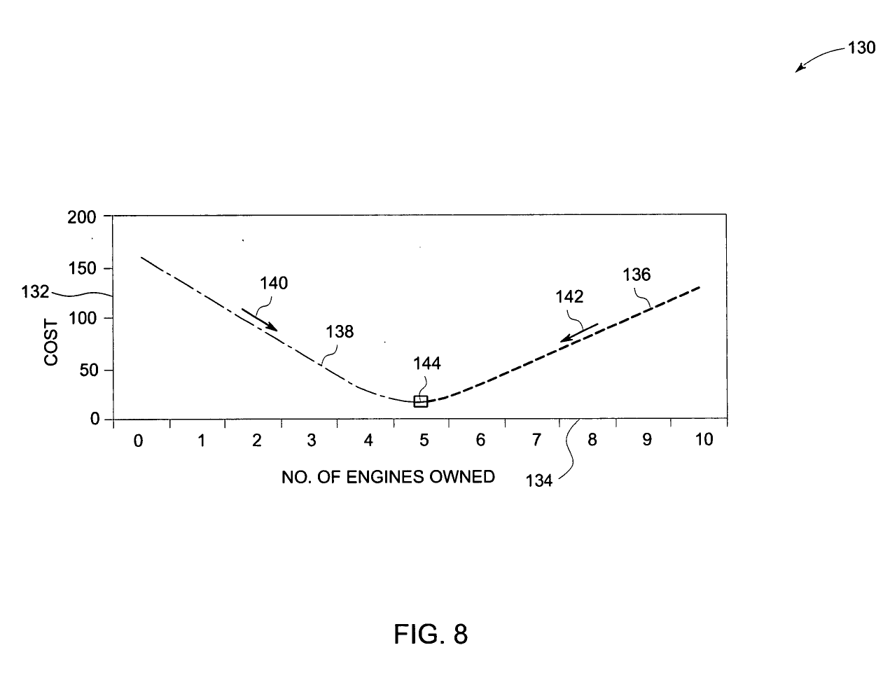

FIG. 8 is a graphical representation (130) of an exemplary cost distribution of managing a spare engine inventory for the total number of required spare engines over a time period. As illustrated, the graph 130 indicates that ten engines are estimated to be required for the given time period. The ordinate axis 132 of the cost distribution 130 represents an expected cost of maintaining the total number of engines and the abscissa axis 134 of the cost distribution 130 represents the number of spare engines owned by the airline or a service provider. The expected cost includes a cost of owning 136 the first number of engines and a cost of leasing 138 the second number of engines. As can be seen, the cost of leasing 138 reduces with an increasing number of owned spare engines, as represented by reference numeral 140. Similarly, the cost of owning 136 reduces, as the number of owned spare engines decreases as represented by reference numeral 142. The above mentioned technique is utilized to determine an optimum number 144 of spare engines to be owned by the asset inventory for the time period to substantially reduce the cost of maintaining the total number of engines. In the illustrated embodiment, the cost of maintaining the total number of engines is minimized to determine the first number of owned engines and the second number of leased engines by balancing the cost of owning the first number of assets against the cost of leasing the second number of assets. In this exemplary embodiment, the optimum number 144 of spare engines to be owned by the asset inventory is five, which results in the estimated least cost of maintaining the total number of engines for the time period. Moreover, the above-mentioned technique improves the profitability on LTSA by predicting the optimal number of spare engines that are required to be owned for a fleet by the inventory.

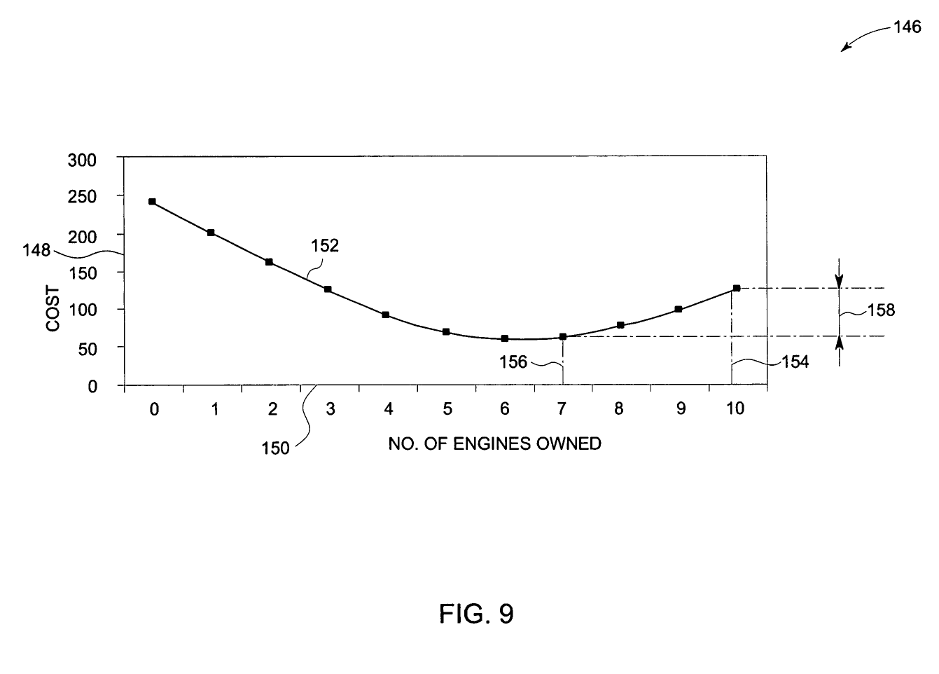

FIG. 9 is a graphical representation of an exemplary cost distribution 146 of managing a spare engine inventory over a period of time for a required number of spare engines. The ordinate axis 148 of the cost distribution 146 represents total cost over a time period for maintaining the required number of spare engines and the abscissa axis 150 represents the number of owned spare engines. As can be seen, the total cost 152 over the time period reduces with the increasing number of owned spare engines up to a certain number of owned spare engines where the cost of owning the additional spare engines is lesser than cost of leasing the spare engines. Alternatively, for any additional requirement the total cost 152 may increase for increasing number of spare engines, as the cost of leasing the additional engines may be less than the cost of owning the additional engines. The above-mentioned technique facilitates determination of the optimum number of engines to be owned and leased by the asset inventory to minimize the cost of maintaining the total number of engines. In the illustrated embodiment, the cost of owning an excess number of spare engines is represented by reference numeral 154 and the cost of owning the optimum number of spare engines is illustrated by reference numeral 156. Thus, optimizing the number of owned spare engines results in a profit 158 in the total cost of managing the asset inventory over the time period.

In certain embodiments, a cost-benefit analysis may be performed over a time period to allocate the asset inventory between leased and owned engines. In this embodiment, the estimated cost of maintaining the total number of engines may be tracked over a time period say a year and the mean yearly estimated cost may be analyzed to determine the optimum number of engines to be owned by the inventory for reducing the total cost of maintaining the total number of assets.

As will be appreciated by those of ordinary skill in the art, the foregoing example, demonstrations, and process steps may be implemented by suitable code on a processor-based system, such as a general-purpose or special-purpose computer. It should also be noted that different implementations of the present technique may perform some or all of the steps described herein in different orders or substantially concurrently, that is, in parallel. Furthermore, the functions may be implemented in a variety of programming languages, such as C++ or JAVA. Such code, as will be appreciated by those of ordinary skill in the art, may be stored or adapted for storage on one or more tangible, machine readable media, such as on memory chips, local or remote hard disks, optical disks (that is, CD's or DVD's), or other media, which may be accessed by a processor-based system to execute the stored code. Note that the tangible media may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of managing an asset inventory, comprising:
obtaining data related to assets of the asset inventory;
analyzing the obtained data to estimate a total number of assets required by the asset inventory over a time period;
determining a first cost of owning an asset and a second cost of leasing an asset; and
allocating the asset inventory between a first number of owned assets and a second number of leased assets to achieve an estimated least-cost value of maintaining the total number of assets over the time period.

2. The method of claim 1, wherein the asset inventory comprises a spare engines inventory and the assets comprise spare engines for a fleet of aircrafts.

3. The method of claim 1, wherein the data related to assets comprise an asset utilization, or an asset lease acquisition cost, or an asset lease utilization cost, or an asset repair cost, or an asset life, or an asset maintenance turnaround time, or an asset transport time, or an asset depreciation, or an asset purchase cost, or an asset storage cost, or an asset ownership cost, or combinations thereof.

4. The method of claim 1, wherein the data related to assets comprises a plurality of failure modes of components of the assets.

5. The method of claim 4, wherein the plurality of failure modes comprise a gear box related failure, or a combustor failure, or a foreign object damage, or a high pressure compressor failure, or a high pressure turbine failure, or a life limited part, or a low pressure system failure, or a maintenance error, or a slow acceleration, or a control failure, or a performance failure, or combinations thereof.

6. The method of claim 1, wherein analyzing the obtained data comprises analyzing the obtained data to determine failure rate distributions for the components of the assets and forecasting failure of the components of the assets over the time period.

7. The method of claim 1, wherein allocating the assets to be owned by the asset inventory comprises balancing the cost of owning the first number of assets against the cost of leasing the second number of assets.

8. The method of claim 7, further comprising employing a stochastic forecast to determine the first number of owned assets and the second number of leased assets for the time period.

9. The method of claim 8, further comprising determining a leasing schedule for leasing the second number of leased assets to substantially reduce the cost of maintaining the total number of assets over the time period.

10. A method of managing an asset inventory, comprising:
obtaining data related to assets for the asset inventory;
analyzing the obtained data to estimate a total number of assets required by the asset inventory over a period of time;
allocating the asset inventory between a first number of owned assets and a second number of leased assets to achieve an estimated least-cost value of maintaining the total number of assets over the period of time; and
determining a schedule for leasing the second number of assets to be leased for the asset inventory.

11. The method of claim 10, wherein the asset inventory comprises a spare engines inventory and the assets comprise spare engines for a fleet of aircrafts.

12. The method of claim 10, wherein the data related to assets comprise an asset utilization, or an asset lease acquisition cost, or an asset lease utilization cost, or an asset repair cost, or an asset life, or an asset maintenance turnaround time, or an asset transport time, or an asset depreciation, or an asset purchase cost, or an asset storage cost, or an asset ownership cost, or combinations thereof.

13. The method of claim 10, wherein analyzing the obtained data comprises analyzing the obtained data to determine failure rate distributions for the components of the assets and forecasting failure of the components of the assets over the time period.

14. The method of claim 10, wherein allocating the asset inventory comprises determining a first cost of owning an asset and a second cost of leasing an asset for the asset inventory.

15. The method of claim 10, wherein determining the schedule for leasing the second number of assets comprises employing a stochastic forecast to estimate time periods for which the second number of the assets is required by the asset inventory.

16. A computer program for managing an asset inventory, the computer program being disposed on one or more tangible media, the computer program comprising:
code for obtaining data related to assets of the asset inventory;
code for analyzing the obtained data to estimate a total number of assets required by the asset inventory over a time period;
code for determining a first cost of owning an asset and a second cost of leasing an asset; and
code for allocating the asset inventory between a first number of owned assets and a second number of leased assets to achieve an estimated least-cost value of maintaining the total number of assets over the time period.

17. The computer program of claim 16, further comprising code for analyzing the obtained data to determine failure rate distributions for the components of the assets and forecasting failure of the components of the assets over the pre-determined period through a processor.

18. The computer program of claim 16, further comprising code for employing a stochastic forecast to determine the first number of assets to be owned by the asset inventory.

19. A computer program for managing an asset inventory, the computer program being disposed on one or more tangible media, the computer program comprising:
code for obtaining data related to assets for the asset inventory;
code for analyzing the obtained data to estimate a total number of assets required by the asset inventory over a period of time;
code for allocating the asset inventory between a first number of owned assets and a second number of leased assets to achieve an estimated least-cost value of maintaining the total number of assets over the period of time; and
code for determining a schedule for leasing the second number of assets to be leased for the asset inventory.

20. The computer program of claim 19, further comprising code for analyzing the obtained data to determine failure rate distributions for the components of the assets and forecasting failure of the components of the assets over the pre-determined period.

21. The computer program of claim 19, further comprising code for determining the second number of assets to be leased by the asset inventory based upon a second coat of leasing an asset and the cost of maintaining the total number of assets.

22. A system for managing an asset inventory, comprising:
a database having data related to assets of the asset inventory; and
a processor configured to analyze the data to estimate a total number of assets required by the asset inventory over a time period and to allocate the asset inventory between a first number of owned assets and a second number of leased assets to substantially reduce a cost of maintaining the total number of assets.

23. The system of claim 22, wherein the processor comprises a simulator configured to determine failure rate distributions for components of the assets over the time period.

24. The system of claim 23, wherein the simulator is configured to forecast failure of the components of the assets over the time period based upon the estimated failure rate distributions for the components.

25. The system of claim 24, wherein the processor is further configured to determine a schedule for leasing the second number of assets to be leased for the asset inventory.
